(19) United States
(12) Patent Application Publication
(10) Pub. No.: US 2026/0135654 A1
(43) Pub. Date: May 14, 2026

(54) SUPER-LIGHTWEIGHT SYNCHRONIZATION SIGNAL BLOCK STRUCTURE USING SUPERIMPOSED PILOTS

(71) Applicant: QUALCOMM Incorporated, San Diego, CA (US)

(72) Inventors: Ram KRIPS, Ramat Gan (IL); Assaf TOUBOUL, Netanya (IL); Gideon Shlomo KUTZ, Ramat Hasharon (IL); Amit BAR-OR TILLINGER, Tel-Aviv (IL); Elad MEIR, Ramat Gan (IL); Lior UZIEL, Hod Hasharon (IL)

(21) Appl. No.: 19/113,388

(22) PCT Filed: Oct. 5, 2023
(86) PCT No.: PCT/US2023/034556

§ 371 Date: Mar. 19, 2025

(30) Foreign Application Priority Data
Nov. 20, 2022 (IL) 298387

(51) Int. Cl. H04L 5/00; H04W 56/00

(52) U.S. Cl. CPC H04L 5/005; H04L 5/0016; H04L 5/0023; H04L 5/0053; H04L 5/0094; H04W 56/0015

(57) ABSTRACT

Methods, systems, and devices for wireless communication are described. In a wireless communication system, a user equipment (UE) may be capable of supporting superimposed pilot signals over a wireless channel (e.g., a data channel). A network entity may provide a pilot table to the UE indicating a set of parameters associated with a set of pilot signals. In addition, the network entity may transmit control signaling to the UE indicating an existence of superimposed pilot signals over the wireless channel. That is, the control signaling may indicate a set of resources associated with the superimposed pilot signals. The UE may monitor the set of resources to measure the pilot signals in accordance with the parameters and the superimposition of the pilot signals over the wireless channel. In some cases, the UE may use the measured pilot signals to perform beam tracking or some other beam management procedure.

### CROSS REFERENCE

The present Application is a 371 national stage filing of International PCT Application No. PCT/US2023/034556 by KRIPS et al. entitled “SUPER-LIGHTWEIGHT SYNCHRONIZATION SIGNAL BLOCK STRUCTURE USING SUPERIMPOSED PILOTS,” filed Oct. 5, 2023; and claims priority to Israel Patent Application No. 298387 by KRIPS et al., entitled “SUPER-LIGHTWEIGHT SYNCHRONIZATION SIGNAL BLOCK STRUCTURE USING SUPERIMPOSED PILOTS,” filed Nov. 20, 2022, each of which is assigned to the assignee hereof, and each of which is expressly incorporated by reference in its entirety herein.

### FIELD OF TECHNOLOGY

The following relates to wireless communication, including super-lightweight synchronization signal block (SSB) structure using superimposed pilots.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a network entity may transmit synchronization signal blocks (SSB) that allow one or more UEs to synchronize with the network entity. In some cases, however, techniques for transmitting such SSBs may be improved.

### SUMMARY

The described techniques relate to improved methods, systems, devices, and apparatuses that support super-lightweight synchronization signal block (SSB) structure using superimposed pilots. In some systems, a network entity may communicate with a user equipment (UE) using one or more superimposed pilot signals instead of orthogonal pilot signals. The UE may receive a first control message indicating a set of parameters for one or more pilot signals to be monitored by the UE. In addition, the UE may receive a second control message indicating a set of resources associated with the one or more pilot signals in accordance with a superimposition of the one or more pilot signals over a wireless channel (e.g., a shared data channel). That is, the UE may receive an indication of the existence of superimposed pilot signals. The UE may monitor the set of resources to measure the one or more pilot signals in accordance with the indicated set of parameters and the superimposition of the one or more pilot signals over the wireless channel. In this way, the UE may monitor same time and frequency resources for both the pilot signals and data, which may reduce overhead. In some cases, the UE may use the measured pilot signals to perform a beam management procedure, such as beam tracking.

A method for wireless communication at a UE is described. The method may include receiving a first control message indicating a set of parameters for one or more pilot signals to be monitored by the UE, receiving a second control message indicating a set of resources associated with the one or more pilot signals in accordance with a superimposition of the one or more pilot signals over a wireless channel, and monitoring the set of resources to measure the one or more pilot signals in accordance with the set of parameters indicated in the first control message and the superimposition of the one or more pilot signals over the wireless channel.

An apparatus for wireless communication at a UE is described. The apparatus may include a processor, memory coupled with the processor, and instructions stored in the memory. The instructions may be executable by the processor to cause the apparatus to receive a first control message indicating a set of parameters for one or more pilot signals to be monitored by the UE, receive a second control message indicating a set of resources associated with the one or more pilot signals in accordance with a superimposition of the one or more pilot signals over a wireless channel, and monitor the set of resources to measure the one or more pilot signals in accordance with the set of parameters indicated in the first control message and the superimposition of the one or more pilot signals over the wireless channel.

Another apparatus for wireless communication at a UE is described. The apparatus may include means for receiving a first control message indicating a set of parameters for one or more pilot signals to be monitored by the UE, means for receiving a second control message indicating a set of resources associated with the one or more pilot signals in accordance with a superimposition of the one or more pilot signals over a wireless channel, and means for monitoring the set of resources to measure the one or more pilot signals in accordance with the set of parameters indicated in the first control message and the superimposition of the one or more pilot signals over the wireless channel.

A non-transitory computer-readable medium storing code for wireless communication at a UE is described. The code may include instructions executable by a processor to receive a first control message indicating a set of parameters for one or more pilot signals to be monitored by the UE, receive a second control message indicating a set of resources associated with the one or more pilot signals in accordance with a superimposition of the one or more pilot signals over a wireless channel, and monitor the set of resources to measure the one or more pilot signals in accordance with the set of parameters indicated in the first control message and the superimposition of the one or more pilot signals over the wireless channel.

Some examples of the method, apparatuses, and non-transitory computer-readable medium described herein may further include operations, features, means, or instructions for transmitting a capability message indicating a capability of the UE to support the superimposition of the one or more pilot signals over the wireless channel.

In some examples of the method, apparatuses, and non-transitory computer-readable medium described herein, receiving the second control message may include operations, features, means, or instructions for receiving downlink control information (DCI) indicating the set of resources associated with the one or more pilot signals in accordance with the superimposition of the one or more pilot signals over the wireless channel.

Some examples of the method, apparatuses, and non-transitory computer-readable medium described herein may further include operations, features, means, or instructions for receiving radio resource control (RRC) signaling indicating the set of parameters for the one or more pilot signals, where the set of parameters indicates a multiplexing associated with the one or more pilot signals and receiving DCI on indicating the set of parameters for a selected pilot signal of the one or more pilot signals.

Some examples of the method, apparatuses, and non-transitory computer-readable medium described herein may further include operations, features, means, or instructions for performing beam tracking of one or more receive beams based on measuring the one or more pilot signals.

Some examples of the method, apparatuses, and non-transitory computer-readable medium described herein may further include operations, features, means, or instructions for performing an iterative demodulation process on the set of resources associated with the one or more pilot signals, where the iterative demodulation process demodulates the wireless channel and the one or more pilot signals separately in accordance with the superimposition of the one or more pilot signals over the wireless channel.

In some examples of the method, apparatuses, and non-transitory computer-readable medium described herein, the set of parameters includes an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

In some examples of the method, apparatuses, and non-transitory computer-readable medium described herein, the one or more pilot signals may be orthogonal to each other based on one or more orthogonal spreading codes, a frequency division multiplexing (FDMing) of the one or more pilot signals with the wireless channel, a time division multiplexing (TDMing) of the one or more pilot signals with the wireless channel, a code division multiplexing (CDMing) of the one or more pilot signals with the wireless channel, or any combination thereof, and where the one or more pilot signals may be non-orthogonal to the wireless channel.

A method for wireless communication at a network entity is described. The method may include transmitting a first control message indicating a set of parameters for one or more pilot signals to be monitored by a UE, transmitting a second control message indicating a set of resources associated with the one or more pilot signals in accordance with a superimposition of the one or more pilot signals over a wireless channel, and transmitting the one or more pilot signals via the set of resources in accordance with the set of parameters indicated in the first control message and the superimposition of the one or more pilot signals over the wireless channel.

An apparatus for wireless communication at a network entity is described. The apparatus may include a processor, memory coupled with the processor, and instructions stored in the memory. The instructions may be executable by the processor to cause the apparatus to transmit a first control message indicating a set of parameters for one or more pilot signals to be monitored by a UE, transmit a second control message indicating a set of resources associated with the one or more pilot signals in accordance with a superimposition of the one or more pilot signals over a wireless channel, and transmit the one or more pilot signals via the set of resources in accordance with the set of parameters indicated in the first control message and the superimposition of the one or more pilot signals over the wireless channel.

Another apparatus for wireless communication at a network entity is described. The apparatus may include means for transmitting a first control message indicating a set of parameters for one or more pilot signals to be monitored by a UE, means for transmitting a second control message indicating a set of resources associated with the one or more pilot signals in accordance with a superimposition of the one or more pilot signals over a wireless channel, and means for transmitting the one or more pilot signals via the set of resources in accordance with the set of parameters indicated in the first control message and the superimposition of the one or more pilot signals over the wireless channel.

A non-transitory computer-readable medium storing code for wireless communication at a network entity is described. The code may include instructions executable by a processor to transmit a first control message indicating a set of parameters for one or more pilot signals to be monitored by a UE, transmit a second control message indicating a set of resources associated with the one or more pilot signals in accordance with a superimposition of the one or more pilot signals over a wireless channel, and transmit the one or more pilot signals via the set of resources in accordance with the set of parameters indicated in the first control message and the superimposition of the one or more pilot signals over the wireless channel.

Some examples of the method, apparatuses, and non-transitory computer-readable medium described herein may further include operations, features, means, or instructions for receiving a capability message indicating a capability of the UE to support the superimposition of the one or more pilot signals over the wireless channel.

In some examples of the method, apparatuses, and non-transitory computer-readable medium described herein, transmitting the second control message may include operations, features, means, or instructions for transmitting DCI indicating the set of resources associated with the one or more pilot signals in accordance with the superimposition of the one or more pilot signals over the wireless channel.

Some examples of the method, apparatuses, and non-transitory computer-readable medium described herein may further include operations, features, means, or instructions for transmitting RRC signaling indicating the set of parameters for the one or more pilot signals, where the set of parameters indicates a multiplexing associated with the one or more pilot signals and transmitting DCI indicating the set of parameters for a selected pilot signal of the one or more pilot signals.

In some examples of the method, apparatuses, and non-transitory computer-readable medium described herein, scheduling transmission of the wireless channel via the set of resources in accordance with the superimposition of the one or more pilot signals over the wireless channel.

In some examples of the method, apparatuses, and non-transitory computer-readable medium described herein, the set of parameters includes an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

In some examples of the method, apparatuses, and non-transitory computer-readable medium described herein, the one or more pilot signals may be orthogonal to each other based on one or more orthogonal spreading codes, an FDMing of the one or more pilot signals with the wireless channel, a TDMing of the one or more pilot signals with the wireless channel, a CDMing of the one or more pilot signals with the wireless channel, or any combination thereof, and where the one or more pilot signals may be non-orthogonal to the wireless channel.

### BRIEF DESCRIPTION OF THE DRAWINGS

FIG. 1 illustrates an example of a wireless communications system that supports a super-lightweight SSB structure using superimposed pilots in accordance with one or more aspects of the present disclosure.

FIG. 2 illustrates an example of a wireless communications system that supports a super-lightweight SSB structure using superimposed pilots in accordance with one or more aspects of the present disclosure.

FIG. 3 illustrates an example of a process flow that supports a super-lightweight SSB structure using superimposed pilots in accordance with one or more aspects of the present disclosure.

FIGS. 4 and 5 illustrate block diagrams of devices that support super-lightweight SSB structure using superimposed pilots in accordance with one or more aspects of the present disclosure.

FIG. 6 illustrates a block diagram of a communications manager that supports a super-lightweight SSB structure using superimposed pilots in accordance with one or more aspects of the present disclosure.

FIG. 7 illustrates a diagram of a system including a device that supports a super-lightweight SSB structure using superimposed pilots in accordance with one or more aspects of the present disclosure.

FIGS. 8 and 9 illustrate block diagrams of devices that support super-lightweight SSB structure using superimposed pilots in accordance with one or more aspects of the present disclosure.

FIG. 10 illustrates a block diagram of a communications manager that supports a super-lightweight SSB structure using superimposed pilots in accordance with one or more aspects of the present disclosure.

FIG. 11 illustrates a diagram of a system including a device that supports a super-lightweight SSB structure using superimposed pilots in accordance with one or more aspects of the present disclosure.

FIGS. 12 through 16 illustrate flowcharts showing methods that support super-lightweight SSB structure using superimposed pilots in accordance with one or more aspects of the present disclosure.

### DETAILED DESCRIPTION

In a wireless communications system, synchronization signal blocks (SSBs) may be used in various scenarios, such as initial acquisition, handover procedures, and beam tracking. In some cases, such as during a handover procedure, a user equipment (UE) may refrain from using a full SSB structure, and instead may use a lightweight SSB. A lightweight SSB may include separate synchronization signals used for initial synchronization, beam tracking, and handover procedures, which may decrease SSB overhead. However, for some beam management procedures, using superimposed pilot signals may further reduce SSB overhead and improve beam tracking. For example, if a UE performs a beam management procedure frequently, the UE may use a superimposed pilot on a shared data channel instead of an orthogonal pilot to reduce resource usage.

The techniques described herein provide for a super-lightweight SSB structure using superimposed pilots. For example, a UE may use the described techniques to receive one or more pilot signal sequences using time and frequency resources that overlap with a physical downlink shared channel (PDSCH) transmission. The UE, which may be capable of receiving superimposed pilots, may receive a first control message indicating a set of parameters for one or more pilot signals. For example, the parameters may include a quantity of ports, a type of multiplexing, and the like. The UE may receive a second control message indicating a set of resources associated with the pilot signals, where the pilot signals are to be superimposed over a wireless channel (e.g., a PDSCH). That is, the second control message may indicate the existence of the superimposed pilot signals. The UE may monitor the set of resources to measure the pilot signals in accordance with the indicated parameters and the superimposition of the pilot signals over the wireless channel. In some cases, the UE may use the measurements to perform channel measurements, beam tracking, or other beam management procedures.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to a super-lightweight SSB structure using superimposed pilots.

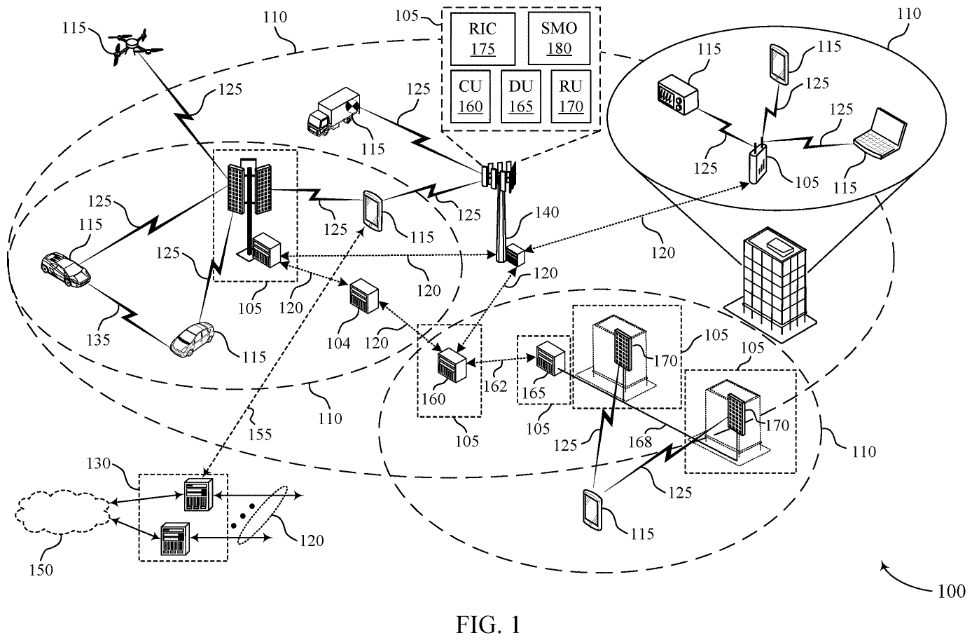

FIG. 1 illustrates an example of a wireless communications system 100 that supports a super-lightweight SSB structure using superimposed pilots in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support a super-lightweight SSB structure using superimposed pilots as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrow band IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In the wireless communications system 100, higher frequency bands (e.g., mmW, sub-THz bands) may rely on beamforming and use a large quantity of transmit beams to provide sufficient coverage to wireless devices such as UEs 115 and network entities 105. To obtain beam synchronization, a network entity 105 may transmit an SSB per transmit beam (e.g., 64 beams may be used) periodically with a fixed time period (e.g., 20 ms). This may result in a large SSB overhead as large quantities of signals are transmitted, per transmit beam, per time period. An SSB may include a waveform of four symbols (e.g., including a primary synchronization signal (PSS), a secondary synchronization signal (SSS), and a physical broadcast channel (PBCH)), with a periodicity of 20 ms. In addition, wireless devices may use SSBs in initial cell acquisition, handover procedures, and beam management procedures (resulting in an overhead of approximately 6%). To reduce SSB overhead, a network entity 105 may transmit modified SSBs. For example, the network entity 105 may use a lightweight SSB structure alternative based on splitting an SSB signal into a standard SSB and a keep alive signal (KAS) for energy saving purposes, particularly in initial access and handover procedures (where the KAS may be used for beam tracking).

Some SSB structures may be based on periodically transmitting an SSB, including four symbols per transmit beam, each fixed time period, which may result in high transmission overhead. For example, a network entity 105 may support single simultaneous beam transmission with a sub-carrier spacing of 120 kHz and a 100 MHz bandwidth. In such cases, the network entity 105 may support 160 slots per 20 ms, and may transmit two beams per slot, such that the transmission of 64 beams in a given time period may use 32 slots. As 160 slots may be available, this process may utilize approximately 20% (e.g., 32/160) of the slots. For a network entity 105 that supports more than one transmit beam simultaneously (and therefore supports frequency division multiplexed (FDMed) SSBs and data), the process may utilize approximately 6%

$$( e . g . , 20 \% * ( \frac{240}{792} ) )$$

of the available resources (or 12% for 128 beams during the given time period, which the network entity 105 may use in higher bands).

In some cases, wireless devices in the wireless communications system 100 may use SSBs for various purposes in mmW and other higher bands. For example, a UE 115 may use SSBs in an initial acquisition procedure, which may occur when a UE 115 enters an on-mode. The initial acquisition procedure may include communicating cell identifiers and cell-critical parameters included in a master information block (MIB), an SSB index for beamforming, frequency offset correction, time offset correction, or any combination thereof. Additionally, or alternatively, a UE 115 may use SSBs for handover decisions, which may include communicating cell identifiers and MIB parameters, fine time adjustments to account for distance from new cells, fine frequency adjustments to account for Doppler from the new cells, an SSB index for beam tracking, or any combination thereof. In some examples, the UE 115 may use SSBs for beam tracking, which may include communicating an SSB index for beamforming, fine time tracking, fine frequency tracking, or any combination thereof.

In some examples, a UE 115 may use a full SSB structure or a modified SSB structure with a KAS for initial acquisition procedures. The latency of such procedures may be high without impacting a quality of service (QoS) or UE experience, implying a low periodicity. In some examples, the UE 115-a may use a partial SSB for handover procedures, where the periodicity of SSB transmissions may be higher than for initial acquisition procedures. In some examples, the UE 115-a may perform beam tracking procedures without PBCHs, PSSs, or both, where the periodicity of SSB transmissions may be higher than initial acquisition and handover procedures to accurately handle UE mobility.

In some examples, a network entity 105 may transmit a lightweight SSB and a KAS for use in a beam management procedure. A lightweight SSB may include two components, an ISS for initial synchronization purposes and an FSS for fast beam tracking and handover purposes. An ISS may include a synchronization signal structure that spreads over four symbols per transmit beam. The network entity 105 may transmit an ISS with a low periodicity of 160 ms, such that the ISS is backward compatible with full-structured SSBs. If such backward compatibility is not required for higher bands, the network entity 105 may use lower periodicities. In some examples, the network entity 105 may use KASs to reduce ISS overhead. The network entity 105 may transmit an FSS using only a KAS having a length of one symbol. Alternatively, the network entity 105 may transmit PSSs and SSSs on two symbols to enable increased time and frequency synchronization. The network entity 105 may cycle through transmit beams every 20 ms, enabling fast beam tracking. As such, a lightweight SSB may include an ISS and an FSS. The ISS may be a waveform of four symbols per SSB (e.g., including a PSS, an SSS, and a PBCH), with a periodicity of 160 ms per beam and usage primarily in initial cell acquisition and in some cases, in handover procedures, beam management procedures, or both. The FSS may be a waveform of one symbol per beam (e.g., including an SSS only), with a periodicity of 20 ms per beam and usage in handover procedures and beam management procedures.

Such an ISS and FSS structure may result in decreased synchronization signal overhead. For example, a network entity 105 may transmit 64 beams using an ISS periodicity of 160 ms and an FSS periodicity of 20 ms. In addition, the network entity 105 may transmit up to eight FSSs per slot (where an FSS is included in one symbol) and up to two ISSs per slot. In such cases, if the network entity 105 supports single SSBs, a lightweight SSB may result in approximately a 6.9% overhead (e.g., 4.4% FSS+2.5% ISS=6.9%) where a full-structure SSB may result in an overhead of 20%. If the network entity 105 supports FDMed SSBs, the lightweight SSB may result in approximately a 2.05% overhead (e.g., 1.3% FSS+0.75% ISS=2.05%), where a full-structured SBS may result in an overhead of 6%.

However, in some examples, the FSS of a lightweight SSB may be replaced with superimposed pilot signals to further reduce SSB overhead and improve beam tracking by using a super-lightweight SSB. Pilot signals may be predefined reference signals (e.g., based on defined reference signal sequences or patterns) transmitted by a network entity 105 to enable a UE 115 or another receiver to estimate a channel. Superimposed pilot signals refer to pilot signals transmitted on top of data symbols in a wireless channel. For example, network entity 105 may sum pilot and data symbols together before transmitting them on same time and frequency resources. In addition, the network entity 105 may refrain from performing frequency division multiplexing (FDMing) or time division multiplexing (TDMing) of SSBs and data, and there may lack any orthogonal resource overhead for this portion of the SSB. Specifically, to further split FSS cycles in this way, the network entity 105 may use low-rate FSS cycles (e.g., 80 ms) for handover purposes and high-rate superimposed synchronization signals (SIPSS) cycles every 20 ms, reclaiming all time resources for the functionality of the SIPSS.

Using a super-lightweight SSB, overhead associated with an ISS may remain unchanged, and FSS overhead may be reduced by a factor of four based on a four times lower periodicity. That is, superimposed pilots may lack overhead because the network entity 105 may refrain from allocating orthogonal time and frequency resources to it. The superimposed pilots may use some power resources fully. For example, a network entity 105 may transmit 64 beams using an ISS periodicity of 160 ms and an FSS periodicity of 80 ms. In addition, the network entity 105 may transmit up to eight FSSs per slot (where an FSS is included in one symbol) and up to two ISSs per slot. In such cases, the use of a super-lightweight SSB may result in approximately a 0.95% overhead (e.g., 0.2% FSS+0.75% ISS=0.95%).

In this way, the network entity 105 may use a super-lightweight SSB with an overhead of approximately 0.95%, where the super-lightweight SSB includes an ISS, and in some cases an FSS, an SIPSS, or both. The ISS may be a waveform of four symbols per SSB (e.g., a PSS, an SSS, and a PBCH), with a periodicity of 160 ms per beam and usage in primarily initial cell synchronization and acquisition, and in some cases in handover procedures, beam management procedures, or both. The FSS may be a waveform of one symbol per beam (e.g., an SSS only), with a periodicity of 160 ms per beam and usage in primarily handover procedures (e.g., utilizes an effective 80 ms periodicity by ISS and FSS combined), and in some cases, beam management procedures. The SIPPS may be a superimposed pilot without any dedicated time and frequency resources, with a periodicity of 20 ms per beam and a usage in beam management procedures.

The wireless communications system 100 may support techniques for converting part of a KAS signal of a lightweight SSB into a superimposed pilot structure. A UE 115 may receive a first control message indicating a set of parameters for one or more pilot signals to be monitored by the UE 115. In addition, the UE 115 may receive a second control message indicating a set of resources associated with the one or more pilot signals in accordance with a superimposition of the one or more pilot signals over a wireless channel (e.g., a shared data channel). That is, the UE 115 may receive an indication of the existence of superimposed pilot signals. The UE 115 may monitor the set of resources to measure the one or more pilot signals in accordance with the indicated set of parameters and the superimposition of the one or more pilot signals over the wireless channel. In this way, the UE 115 may monitor same time and frequency resources for both the pilot signals and data, which may reduce overhead. In some cases, the UE 115 may use the measured pilot signals to perform abeam management procedure, such as beam tracking.

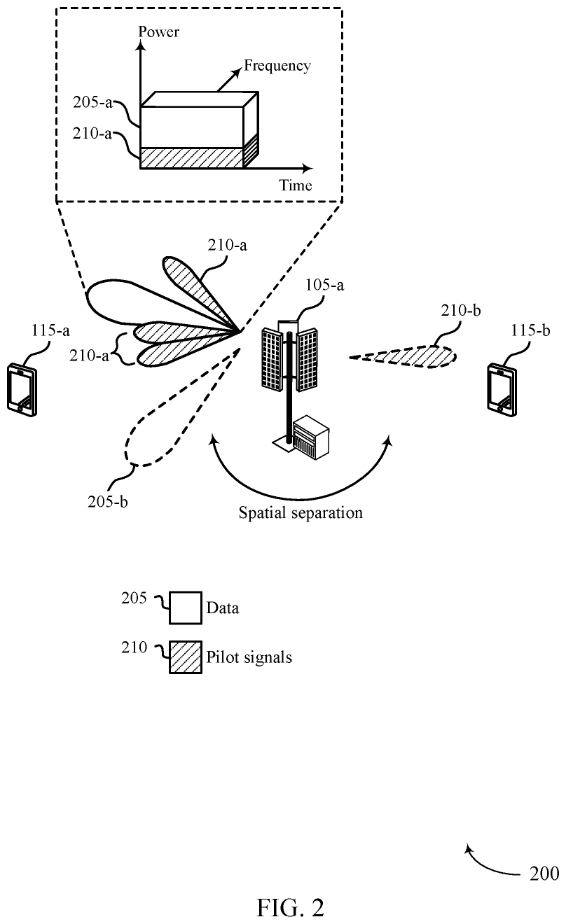

FIG. 2 illustrates an example of a wireless communications system 200 that supports a super-lightweight SSB structure using superimposed pilots in accordance with one or more aspects of the present disclosure. In some examples, the wireless communications system 200 may implement aspects of the wireless communications system 100 or may be implemented by aspects of the wireless communications system 100. For example, the wireless communications system 200 may include a UE 115-a, a UE 115-b, and a network entity 105-a, which may be examples of corresponding devices described herein. In some examples, the UE 115-a and the network entity 105-a may support the superimposition of pilot signals 210 over a wireless channel to reduce overhead.

The wireless communications system 200 may support communications between the network entity 105-a and the UEs 115. For example, the network entity 105-a may communicate downlink transmissions with the UE 115-a and the UE 115-b over a communication link, which may be an example of a communication link 125 described herein with reference to FIG. 1. In some cases, the network entity 105-a may be able to transmit signals to the UEs 115 using some combination of time resources, frequency resources, power resources, or any combination thereof.

In some cases, the UE 115-a may report a capability to support a superimposed pilot scheme. The capability may include partial support, for example, a limitation on a quantity of superimposed ports the UE 115-a may support. For example, the UE 115-a may transmit a capability message to the network entity 105-a indicating a capability of the UE 115-a to support the superimposition of one or more pilot signals 210-a over a wireless channel (e.g., over data 205-a).

The network entity 105-a may transmit control signaling to the UE 115-a indicating a configuration of the superimposition of one or more pilot signals 210-a over data 205-a of the wireless channel, where the pilot signals 210-a may partially overlap the data 205-a. In some examples, the network entity 105-a may transmit a first control message to the UE 115-a indicating a set of parameters for one or more pilot signals 210-a to be monitored by the UE 115-a. For example, the control signaling may include a pilot table (e.g., similar to a CSI-RS configuration) including the set of parameters. The set of parameters may include an indication of a quantity of ports associated with the pilot signals 210-a, a span of symbols to be used for (e.g., associated with) with the pilot signals 210-a superimposed within a set of resources associated with the pilot signals 210-a, an indication of resource blocks used for (e.g., associated with) the pilot signals 210-a within the set of resources, or a combination thereof. Additionally, or alternatively, the set of parameters may include an indication of multiplexing between a set of ports associated with the pilot signals 210-a, where the multiplexing may include a TDM scheme, an FDM scheme, a CDM scheme, or a mixed scheme. Additionally, or alternatively, the set of parameters may indicate a relative allocated power versus a data power, which may assist in estimating one or more parameters at the UE 115-a (e.g., a power allocation associated with the pilot signals 210-a), a beam identifier associated with the pilot signals 210-a, or any combination thereof.

In some cases, the network entity 105-a may transmit control signaling indicating the existence of the superimposed pilot signals 210-a and their type. For example, the network entity 105-a may transmit a second control message to the UE 115-a indicating a set of resources associated with the pilot signals 210-a in accordance with the superimposition of the pilot signals 210-a over the data 205-a of the wireless channel. In some examples, the second control message may be a downlink control information (DCI) message. The set of resources may include time resources, frequency resources, and power resources. For example, the network entity 105-a may configure the pilot signals 210-a to share same time and frequency resources as the data 205-a, but to have its own power resources. In superimposing the pilot signals 210-a on top of the data 205-a, the network entity 105-a may sum pilot and data symbols together and transmitting the summed pilot and data symbols on the same time and frequency resources. The second control message may indicate the resources on which the UE 115-a may monitor for the pilot signals 210-a. It should be noted that the UE 115-a may receive additional control messages configuring the superimposed pilot signals and transmissions using the superimposed pilot signals.

Alternatively, the network entity 105-a may signal multiple options for multiplexing one or more superimposed pilot signals. For example, the network entity 105-a may transmit RRC signaling to the UE 115-a indicating the set of parameters for the pilot signals 210-a, where the set of parameters indicates a multiplexing (e.g., TDM, FDM, CDM, or mixed multiplexing scheme) the network entity 105-a may use to superimpose several beams together in a same slot. For example, the network entity 105-a may superimpose the pilot signals 210-a and additional pilot signals 210 together in a same slot on top of the data 205-a. To transmit the pilot signals 210-a alone, the network entity 105-a may refrain from multiplexing the pilot signals 210-a. In this way, if the network entity 105-a transmits a single superimposed pilot signal 210-a (e.g., pilot beam) at a same slot, then no multiplexing occurs. Alternatively, if the network entity 105-a transmits multiple superimposed pilot signals 210-a (e.g., pilot beams) at a same slot, the network entity 105-a multiplexes the pilot signals 210-a among themselves and superimposes the multiplexed pilot signals 210-a on the data 205-a. Then, the network entity 105-a may signal a dynamic selection of a type of multiplexing being currently used. For example, the network entity 105-a may transmit DCI indicating the set of parameters for a selected pilot signal 210-a of the one or more pilot signals 210-a.

In some cases, the UE 115-a may monitor for the pilot signals 210-a and the data 205-a and decode the respective transmissions to perform a beam management procedure. The UE 115-a may monitor the set of resources to measure the pilot signals 210-a in accordance with the set of parameters indicated in the first control message and the superimposition of the one or more pilot signals 210-a over the data 205-a of the wireless channel. In some cases, the UE 115-a may perform beam tracking on one or more receive beams based on measuring the pilot signals 210-a. The UE 115-a may use multiple receive beams, such that performing beam tracking may include selecting a transmit-receive beam pair. In the case of an unmodified SSB, if the UE 115-a evaluates four receive beams, the UE 115-a may cycle through at least 80 ms (e.g., 4*20 ms=80 ms) to evaluate each possible transmit-receive beam pair, a relatively long selection process. However, superimposed pilot signals may be more suitable for beam tracking as they may enable the UE 115-a to evaluate multiple receive beams per SIPSS instance. For example, the UE 115-a may estimate the pilot signals 210-a using one receive beam in a first half of a slot and another receive beam in a second half of the slot. As such, the UE 115-a may evaluate two receive beams per pilot signal instance using approximately 3 dB or less in each beam-evaluated SNR.

Regarding superimposed pilot signals 210-a, each beam may be superimposed on a slot such that the network entity 105-a may transmit the pilot signals 210-a over each resource in time and frequency with a low power (e.g., 20 dB below the data power). Alternatively, the network entity 105-a may multiplex the pilot signals 210-a over the data 205-a on data symbols only. That is, the pilot signals 210-a may not be superimposed on symbols used for control (e.g., physical downlink control channel (PDCCH) transmissions) or symbols used for PDSCH demodulation reference signals (DMRSs). The pilot signals 210-a may sweep through each transmit beam of the network entity 105-a per 20 ms (e.g., similar to behavior of an SSB). As the network entity 105-a may support 160 slots per 20 ms (e.g., for mmW communications with a subcarrier spacing of 120 MHz), the network entity 105-a may support up to 160 beams.

Alternatively, the network entity 105-a may superimpose multiple pilot signals 210-a. For example, the network entity 105-a may superimpose two, three, or more beams in a single slot such that the network entity 105-a may support 320 beams, 480 beams, or more, respectively, for a single SSB cycle which may be suitable for sub-THz bands. The superimposed pilot signals 210-a may maintain orthogonality between themselves by using orthogonal spreading codes (e.g., using TDM, FDM, CDM), but may be non-orthogonal to the data 205-a. For example, for multiplexing two ports, each with a power that is 20 dB below the data 205-a, an overall power of the pilot signals 210-a may be-17 dB compared to the data 205-a.

The pilot signals 210-a may include more than one beam, in some cases simultaneously, in different directions. In some examples, the UE 115-a may obtain an underlying superimposed pilot signal channel per port by de-spreading and averaging over time and frequency resources, which may provide processing gain as the data 205-a is suppressed. In this way, the pilot signals 210-a may be orthogonal to each other based on one or more orthogonal spreading codes, an FDMing of the pilot signals 210-a on the data 205-a of the wireless channel, a TDMing of the pilot signals 210-a on the data 205-a of the wireless channel, a CDMing of the pilot signals 210-a on the data 205-a of the wireless channel, or a combination thereof, where the pilot signals 210-a may be non-orthogonal to the wireless channel. That is, the pilot signals 210-a may use the same time and frequency resources as the data 205-a, where the pilot signals 210-a may be partially superimposed over the data 205-a. The network entity 105-a may signal such configuration information (e.g., partial superimposition) to the UE 115-a.

In some cases, the network entity 105-a may utilize SIPSS to serve PDSCH users (e.g., the UE 115-a) and tracking users (e.g., the UE 115-b) simultaneously, or two tracking users (e.g., the UE 115-b and another tracking device) simultaneously. For example, the network entity 105-a may communicate with one UE 115 using data transmissions and a different UE 115 without data transmissions, or two UEs 115 with data transmissions (e.g., where a first half of a slot of a data transmission includes data, pilots, or both for the UE 115-a, and a second half of the slot includes data, pilots, or both for the UE 115-b). During transmission of the pilot signals 210, the network entity 105-a may schedule and transmit PDSCH data (e.g., the data 205 via a wireless channel) to the UE 115-a or multiple UEs 115 that use spatially, semi-orthogonal beam directions. For example, the UE 115-a (e.g., UE A) may receive data 205-b (e.g., PDSCH data) via a beam while the UE 115-b (e.g., UE B) may monitor a SIPSS beam for one or more pilot signals 210-b. The UE 115-a, a data user, may experience an SNR of 40 dB based on a 20 dB spatial separation and a 20 dB ratio of the data 205-b to the pilot signal 210-b (e.g., a pilot beam). The UE 115-b, a tracking user, may experience an SNR of 20 dB based on a 20 dB spatial separation and a 20 dB processing gain of the pilot signals 210-b.

In some examples, the network entity 105-a may schedule the data 205-b and the pilot signal 210-b with such spatial separation if the UE 115-a and the UE 115-b lack a capability to support superimposition of the pilot signals 210-b over the data 205-b. In this way, if the network entity 105-a may schedule transmission of the pilot signal 210-b in the spatial direction of the UE 115-b, the network entity 105-a may automatically schedule transmission of the data 205-b in an orthogonal direction to that of the pilot signal 210-b, thus toward the UE 115-a.

In some examples, the network entity 105-a may utilize combined spatial separation (between beams associated with the data 205-a and the pilot signals 210-a) and the superimposition of the pilot signals 210-a to guarantee sufficient separation between transmissions and simultaneously serving data and beam tracking users (e.g., the UE 115-a and the UE 115-b) with sufficient SNRs. In this way, the network entity 105-a may fix the SIPSS transmissions and schedule transmissions of the data 205-a opportunistically to semi-orthogonal directions. For example, if the network entity 105-a uses 64 beams, it may be that when transmitting pilot signals 210 on one beam, eight other beams may be spatially close. Therefore, the network entity 105-a may refrain from scheduling UEs 115 to receive transmissions in a corresponding slot. The remaining 56 beams may be spatially separated, and thus the network entity 105-a may use the remaining beams to transmit the data 205 (e.g., PDSCH transmissions).

Alternatively, the network entity 105-a may transmit the pilot signals 210-a superimposed over the data 205-a to the UE 115-a or the UE 115-b if the UEs 115 are capable of supporting and demodulating superimposed pilot signals, the network entity 105-a may transmit the data 205-a (e.g., PDSCH data) and the superimposed pilot signals 210-a with no spatial separation if the UE 115-a (e.g., a receiver) employs an iterative algorithm for demodulating the data 205-a and the pilot signals 210-a simultaneously. The UE 115-a may signal its capability to support such a demodulation process in the capability message, and the network entity 105-a may consider this capability when scheduling transmissions of the data 205-a. As such, the UE 115-a may perform an iterative demodulation process on the set of resources associated with the one or more pilot signals, where the iterative demodulation process demodulates the wireless channel including the data 205-a and the pilot signals 210-a separately in accordance with the superimposition of the pilot signals 210-a over the data 205-a.

Utilizing the pilot signals 210-a superimposed over the data 205-a in a wireless channel may result in improved analysis of time and frequency behavior of a SIPSS port, as it may cover entire time and frequency resources. The UE 115-a may improve precoding in frequency-selective channels and channel prediction (and thus, improved precoding) in time-selective channels. Additionally, the techniques described herein may reduce SSB overhead by removing orthogonal resources used for SSB transmissions. While a slot the pilot signals 210-a are transmitted in may not require orthogonal resources, for other SSB functionalities (e.g., initial acquisition and handover), some orthogonal resources may still be used. In addition to decreasing overhead, using superimposed pilot may result in improved beam tracking by enabling a wireless device to evaluate multiple receive beams on a same SSB instance, better predict channel time variations, or both. In this way, energy savings in the wireless communications system 200 may increase.

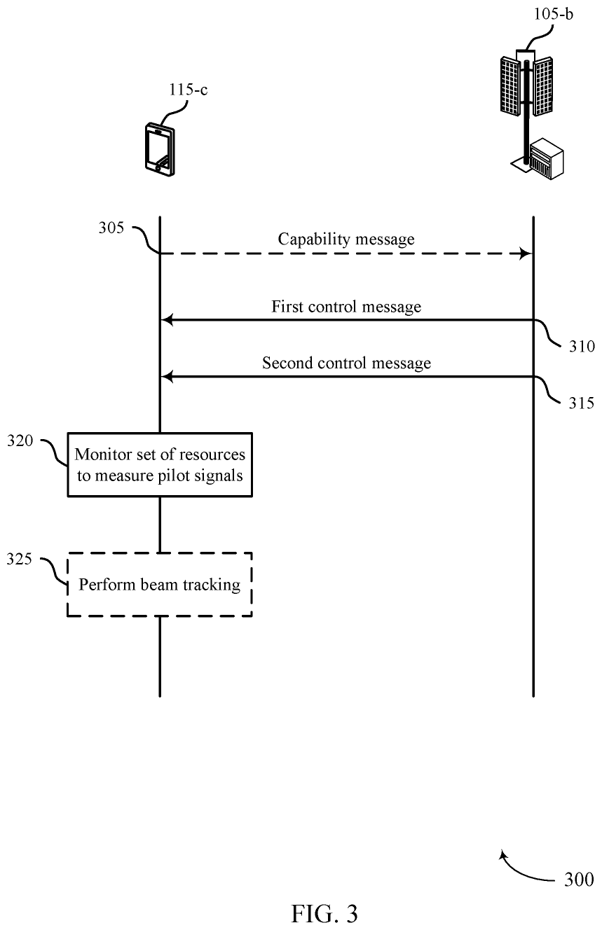

FIG. 3 illustrates an example of a process flow 300 that supports a super-lightweight SSB structure using superimposed pilots in accordance with one or more aspects of the present disclosure. The process flow 300 may implement aspects of wireless communications systems 100 and 200, or may be implemented by aspects of the wireless communications systems 100 and 200. For example, the process flow 300 may illustrate operations between a UE 115-c and a network entity 105-b, which may be examples of corresponding devices described herein. In the following description of the process flow 300, the operations between the UE 115-c and the network entity 105-b may be transmitted in a different order than the example order shown, or the operations performed by the UE 115-c and the network entity 105-b may be performed in different orders or at different times. Some operations may also be omitted from the process flow 300, and other operations may be added to the process flow 300.

At 305, the UE 115-c may transmit, to the network entity 105-b, a capability message indicating a capability of the UE 115-c to support the superimposition of the one or more pilot signals over a wireless channel (e.g., over data of a wireless channel). In some examples, the capability message may indicate a partial capability of the UE 115-c to support the superimposition. For example, the UE 115-c may support a particular quantity of superimposed pilot signals. The capability message may be, for example, an RRC layer message provided by the UE 115-c when a connection is established or modified with or via the network entity 105-b.

At 310, the UE 115-c may receive, from the network entity 105-b, a first control message indicating a set of parameters for the one or more pilot signals to be monitored by the UE 115-c. In some cases, the set of parameters may include a quantity of ports, a span of symbols used for the superimposed pilot signals, a quantity of resource blocks used for the superimposed pilot signals, a type of multiplexing associated with the pilot signals (e.g., TDM, FDM, CDM, or a mixed scheme), an allocated or used power, a beam identifier, or any combination thereof. The first control message may include, for example, an RRC message, MAC control element (MAC-CE) message, or a higher layer signal that specifies the set of parameters for the one or more pilot signals to be monitored by the UE 115-c.

At 315, the UE 115-c may receive, from the network entity 105-b, a second control message indicating a set of resources associated with the one or more pilot signals in accordance with a superimposition of the one or more pilot signals over the wireless channel. In some examples, the second control message may include a DCI message, an RRC signaling, or both. In addition, the set of resources may include time and frequency resources shared by the one or more pilot signals and the wireless channel, and power resources used for the pilot signals and the wireless channel separately.

At 320, the UE 115-c may monitor the set of resources to measure the one or more pilot signals in accordance with the set of parameters indicated in the first control message and the superimposition of the one or more pilot signals over the wireless channel. That is, the UE 115-c may monitor time and frequency resources and demodulate the pilot signals and data transmitted via the wireless channel.

At 325, the UE 115-c may perform beam tracking of one or more receive beams based on measuring the one or more pilot signals. In some examples, the UE 115-c may perform other beam management procedures based on measuring the pilot signals.

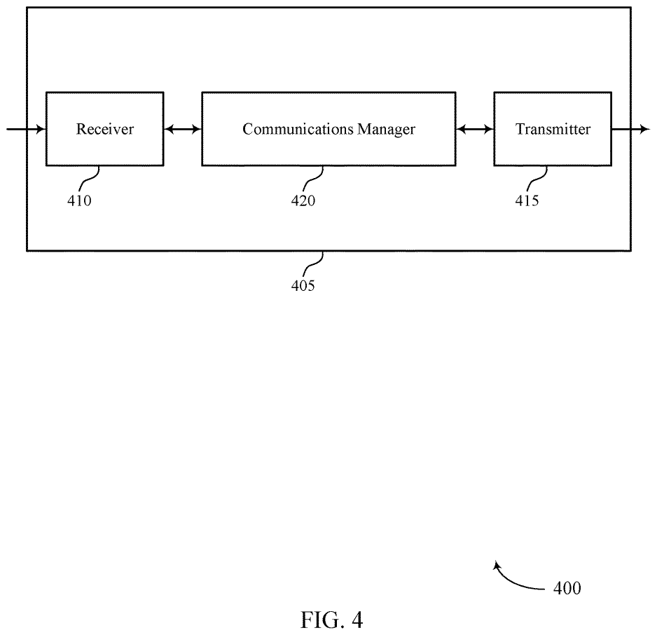

FIG. 4 illustrates a block diagram 400 of a device 405 that supports a super-lightweight SSB structure using superimposed pilots in accordance with one or more aspects of the present disclosure. The device 405 may be an example of aspects of a UE 115 as described herein. The device 405 may include a receiver 410, a transmitter 415, and a communications manager 420. The device 405 may also include a processor. Each of these components may be in communication with one another (e.g., via one or more buses).

The receiver 410 may provide a means for receiving information such as packets, user data, control information, or any combination thereof associated with various information channels (e.g., control channels, data channels, information channels related to super-lightweight SSB structure using superimposed pilots). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to super-lightweight SSB structure using superimposed pilots). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of super-lightweight SSB structure using superimposed pilots as described herein. For example, the communications manager 420, the receiver 410, the transmitter 415, or various combinations or components thereof may support a method for performing one or more of the functions described herein.

In some examples, the communications manager 420, the receiver 410, the transmitter 415, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 420, the receiver 410, the transmitter 415, or various combinations or components thereof may be implemented in code (e.g., as communications management software or firmware) executed by a processor. If implemented in code executed by a processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communication at a UE in accordance with examples as disclosed herein. For example, the communications manager 420 may be configured as or otherwise support a means for receiving a first control message indicating a set of parameters for one or more pilot signals to be monitored by the UE. The communications manager 420 may be configured as or otherwise support a means for receiving a second control message indicating a set of resources associated with the one or more pilot signals in accordance with a superimposition of the one or more pilot signals over a wireless channel. The communications manager 420 may be configured as or otherwise support a means for monitoring the set of resources to measure the one or more pilot signals in accordance with the set of parameters indicated in the first control message and the superimposition of the one or more pilot signals over the wireless channel.

By including or configuring the communications manager 420 in accordance with examples as described herein, the device 405 (e.g., a processor controlling or otherwise coupled with the receiver 410, the transmitter 415, the communications manager 420, or a combination thereof) may support techniques for a super-lightweight SSB structure using pilot signals superimposed over data of a wireless channel, which may decrease SSB overhead and decrease latency as the superimposed pilot signals use the same time and frequency resources as the data.

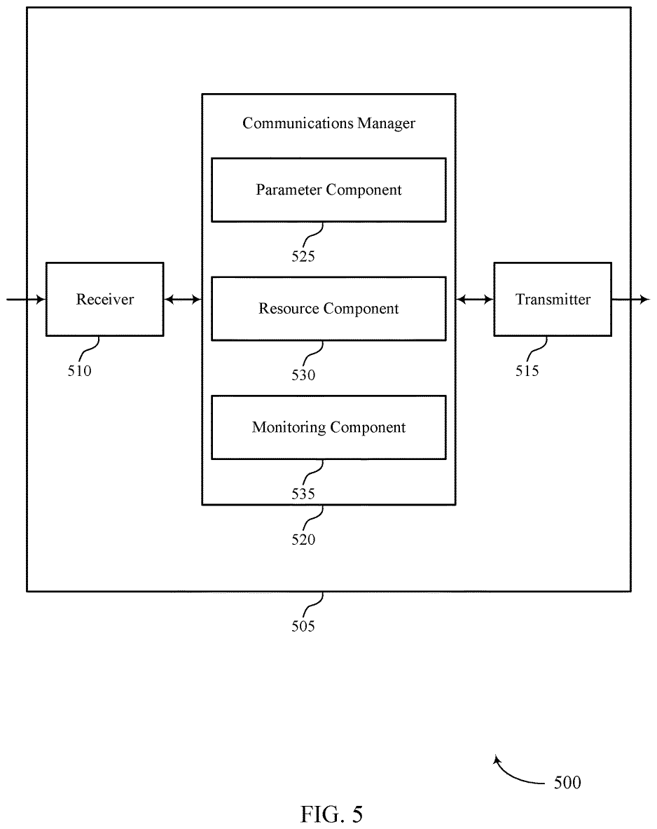

FIG. 5 illustrates a block diagram 500 of a device 505 that supports a super-lightweight SSB structure using superimposed pilots in accordance with one or more aspects of the present disclosure. The device 505 may be an example of aspects of a device 405 or a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to super-lightweight SSB structure using superimposed pilots). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to super-lightweight SSB structure using superimposed pilots). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of super-lightweight SSB structure using superimposed pilots as described herein. For example, the communications manager 520 may include a parameter component 525, a resource component 530, a monitoring component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. The parameter component 525 may be configured as or otherwise support a means for receiving a first control message indicating a set of parameters for one or more pilot signals to be monitored by the UE. The resource component 530 may be configured as or otherwise support a means for receiving a second control message indicating a set of resources associated with the one or more pilot signals in accordance with a superimposition of the one or more pilot signals over a wireless channel. The monitoring component 535 may be configured as or otherwise support a means for monitoring the set of resources to measure the one or more pilot signals in accordance with the set of parameters indicated in the first control message and the superimposition of the one or more pilot signals over the wireless channel.

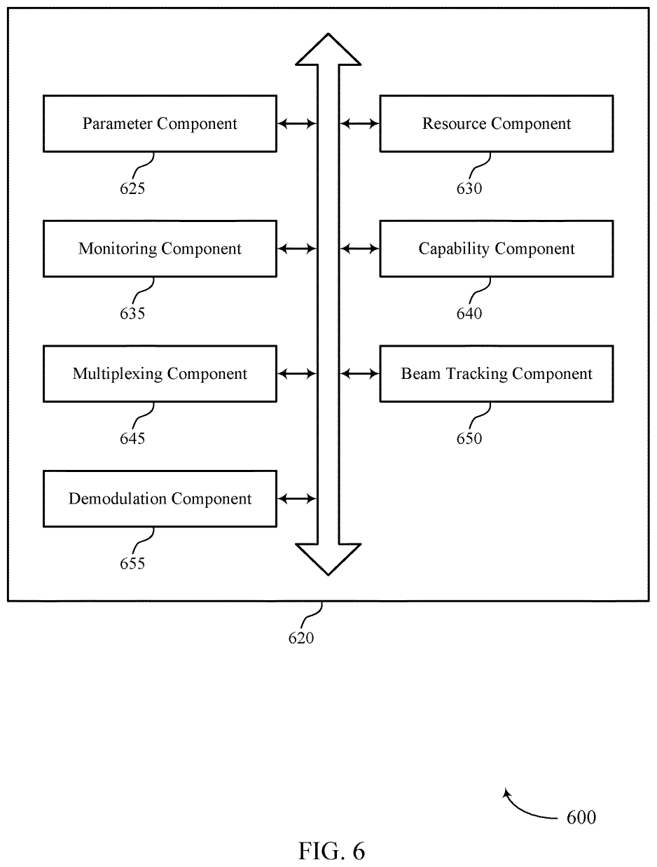

FIG. 6 illustrates a block diagram 600 of a communications manager 620 that supports a super-lightweight SSB structure using superimposed pilots in accordance with one or more aspects of the present disclosure. The communications manager 620 may be an example of aspects of a communications manager 420, a communications manager 520, or both, as described herein. The communications manager 620, or various components thereof, may be an example of means for performing various aspects of super-lightweight SSB structure using superimposed pilots as described herein. For example, the communications manager 620 may include a parameter component 625, a resource component 630, a monitoring component 635, a capability component 640, a multiplexing component 645, a beam tracking component 650, a demodulation component 655, or any combination thereof. Each of these components may communicate, directly or indirectly, with one another (e.g., via one or more buses).

The communications manager 620 may support wireless communication at a UE in accordance with examples as disclosed herein. The parameter component 625 may be configured as or otherwise support a means for receiving a first control message indicating a set of parameters for one or more pilot signals to be monitored by the UE. The resource component 630 may be configured as or otherwise support a means for receiving a second control message indicating a set of resources associated with the one or more pilot signals in accordance with a superimposition of the one or more pilot signals over a wireless channel. The monitoring component 635 may be configured as or otherwise support a means for monitoring the set of resources to measure the one or more pilot signals in accordance with the set of parameters indicated in the first control message and the superimposition of the one or more pilot signals over the wireless channel.

In some examples, the capability component 640 may be configured as or otherwise support a means for transmitting a capability message indicating a capability of the UE to support the superimposition of the one or more pilot signals over the wireless channel.

In some examples, to support receiving the second control message, the resource component 630 may be configured as or otherwise support a means for receiving DCI indicating the set of resources associated with the one or more pilot signals in accordance with the superimposition of the one or more pilot signals over the wireless channel.

In some examples, the multiplexing component 645 may be configured as or otherwise support a means for receiving RRC signaling indicating the set of parameters for the one or more pilot signals, where the set of parameters indicates a multiplexing associated with the one or more pilot signals. In some examples, the multiplexing component 645 may be configured as or otherwise support a means for receiving DCI indicating the set of parameters for a selected pilot signal of the one or more pilot signals.

In some examples, the beam tracking component 650 may be configured as or otherwise support a means for performing beam tracking of one or more receive beams based on measuring the one or more pilot signals.

In some examples, the demodulation component 655 may be configured as or otherwise support a means for performing an iterative demodulation process on the set of resources associated with the one or more pilot signals, where the iterative demodulation process demodulates the wireless channel and the one or more pilot signals separately in accordance with the superimposition of the one or more pilot signals over the wireless channel.

In some examples, the set of parameters includes an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

In some examples, the one or more pilot signals are orthogonal to each other based on one or more orthogonal spreading codes, a FDMing of the one or more pilot signals with the wireless channel, a TDMing of the one or more pilot signals with the wireless channel, a CDMing of the one or more pilot signals with the wireless channel, or any combination thereof, and where the one or more pilot signals are non-orthogonal to the wireless channel.

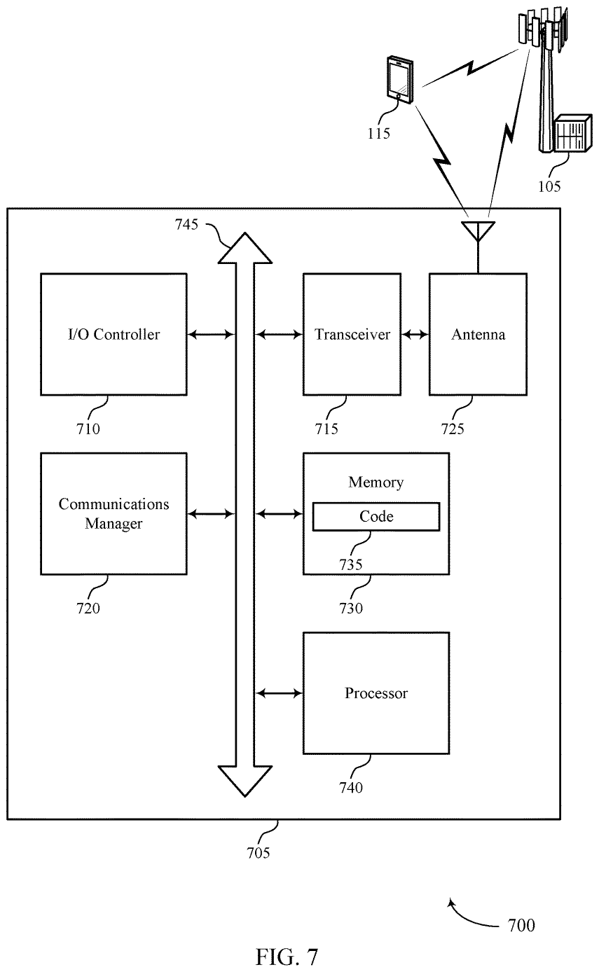

FIG. 7 illustrates a diagram of a system 700 including a device 705 that supports a super-lightweight SSB structure using superimposed pilots in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, a memory 730, code 735, and a processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of a processor, such as the processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The memory 730 may include random access memory (RAM) and read-only memory (ROM). The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some cases, the code 735 may not be directly executable by the processor 740 but may cause a computer (e.g., when compiled and executed) to perform functions described herein. In some cases, the memory 730 may contain, among other things, a basic I/O system (BIOS) which may control basic hardware or software operation such as the interaction with peripheral components or devices.

The processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In some other cases, a memory controller may be integrated into the processor 740. The processor 740 may be configured to execute computer-readable instructions stored in a memory (e.g., the memory 730) to cause the device 705 to perform various functions (e.g., functions or tasks supporting super-lightweight SSB structure using superimposed pilots). For example, the device 705 or a component of the device 705 may include a processor 740 and memory 730 coupled with or to the processor 740, the processor 740 and memory 730 configured to perform various functions described herein.

The communications manager 720 may support wireless communication at a UE in accordance with examples as disclosed herein. For example, the communications manager 720 may be configured as or otherwise support a means for receiving a first control message indicating a set of parameters for one or more pilot signals to be monitored by the UE. The communications manager 720 may be configured as or otherwise support a means for receiving a second control message indicating a set of resources associated with the one or more pilot signals in accordance with a superimposition of the one or more pilot signals over a wireless channel. The communications manager 720 may be configured as or otherwise support a means for monitoring the set of resources to measure the one or more pilot signals in accordance with the set of parameters indicated in the first control message and the superimposition of the one or more pilot signals over the wireless channel.

By including or configuring the communications manager 720 in accordance with examples as described herein, the device 705 may support techniques for a super-lightweight SSB structure using pilot signals superimposed over data of a wireless channel, which may decrease SSB overhead and decrease latency as the superimposed pilot signals use the same time and frequency resources as the data.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of super-lightweight SSB structure using superimposed pilots as described herein, or the processor 740 and the memory 730 may be otherwise configured to perform or support such operations.

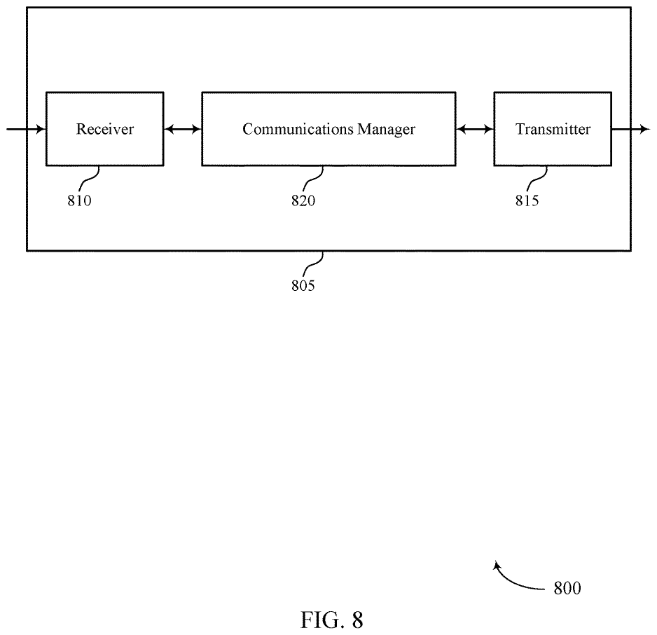

FIG. 8 illustrates a block diagram 800 of a device 805 that supports a super-lightweight SSB structure using superimposed pilots in accordance with one or more aspects of the present disclosure. The device 805 may be an example of aspects of a network entity 105 as described herein. The device 805 may include a receiver 810, a transmitter 815, and a communications manager 820. The device 805 may also include a processor. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of super-lightweight SSB structure using superimposed pilots as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a network entity in accordance with examples as disclosed herein. For example, the communications manager 820 may be configured as or otherwise support a means for transmitting a first control message indicating a set of parameters for one or more pilot signals to be monitored by a UE. The communications manager 820 may be configured as or otherwise support a means for transmitting a second control message indicating a set of resources associated with the one or more pilot signals in accordance with a superimposition of the one or more pilot signals over a wireless channel. The communications manager 820 may be configured as or otherwise support a means for transmitting the one or more pilot signals via the set of resources in accordance with the set of parameters indicated in the first control message and the superimposition of the one or more pilot signals over the wireless channel.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for a super-lightweight SSB structure using pilot signals superimposed over data of a wireless channel, which may decrease SSB overhead and decrease latency as the superimposed pilot signals use the same time and frequency resources as the data.

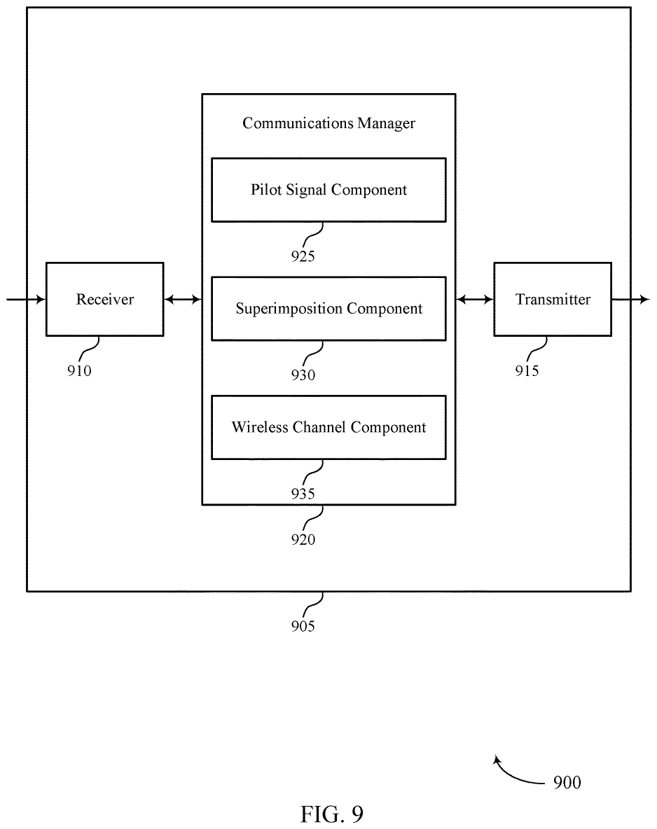

FIG. 9 illustrates a block diagram 900 of a device 905 that supports a super-lightweight SSB structure using superimposed pilots in accordance with one or more aspects of the present disclosure. The device 905 may be an example of aspects of a device 805 or a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of super-lightweight SSB structure using superimposed pilots as described herein. For example, the communications manager 920 may include a pilot signal component 925, a superimposition component 930, a wireless channel component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity in accordance with examples as disclosed herein. The pilot signal component 925 may be configured as or otherwise support a means for transmitting a first control message indicating a set of parameters for one or more pilot signals to be monitored by a UE. The superimposition component 930 may be configured as or otherwise support a means for transmitting a second control message indicating a set of resources associated with the one or more pilot signals in accordance with a superimposition of the one or more pilot signals over a wireless channel. The wireless channel component 935 may be configured as or otherwise support a means for transmitting the one or more pilot signals via the set of resources in accordance with the set of parameters indicated in the first control message and the superimposition of the one or more pilot signals over the wireless channel.

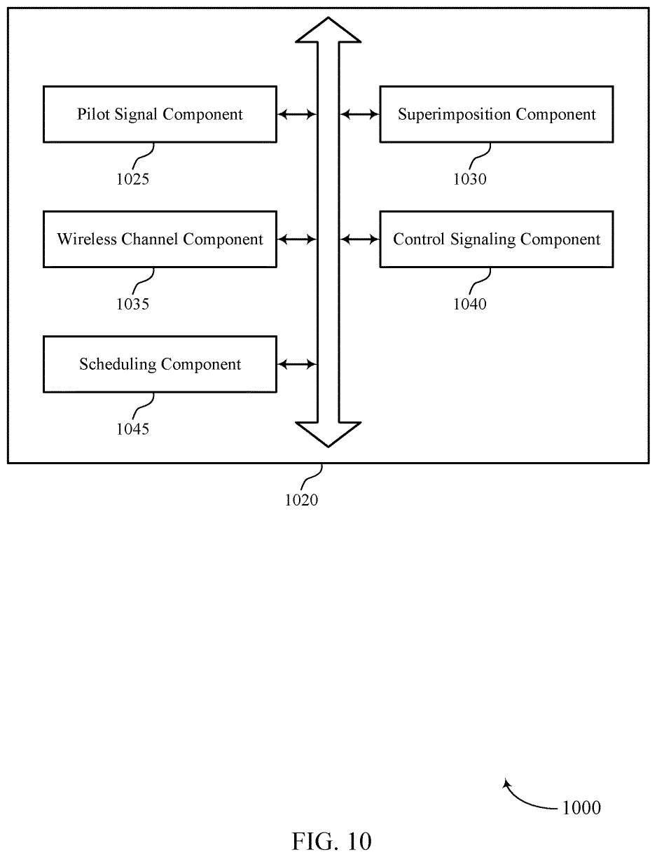

FIG. 10 illustrates a block diagram 1000 of a communications manager 1020 that supports a super-lightweight SSB structure using superimposed pilots in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of super-lightweight SSB structure using superimposed pilots as described herein. For example, the communications manager 1020 may include a pilot signal component 1025, a superimposition component 1030, a wireless channel component 1035, a control signaling component 1040, a scheduling component 1045, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communication at a network entity in accordance with examples as disclosed herein. The pilot signal component 1025 may be configured as or otherwise support a means for transmitting a first control message indicating a set of parameters for one or more pilot signals to be monitored by a UE. The superimposition component 1030 may be configured as or otherwise support a means for transmitting a second control message indicating a set of resources associated with the one or more pilot signals in accordance with a superimposition of the one or more pilot signals over a wireless channel. The wireless channel component 1035 may be configured as or otherwise support a means for transmitting the one or more pilot signals via the set of resources in accordance with the set of parameters indicated in the first control message and the superimposition of the one or more pilot signals over the wireless channel.

In some examples, the control signaling component 1040 may be configured as or otherwise support a means for receiving a capability message indicating a capability of the UE to support the superimposition of the one or more pilot signals over the wireless channel.

In some examples, to support transmitting the second control message, the control signaling component 1040 may be configured as or otherwise support a means for transmitting DCI indicating the set of resources associated with the one or more pilot signals in accordance with the superimposition of the one or more pilot signals over the wireless channel.

In some examples, the control signaling component 1040 may be configured as or otherwise support a means for transmitting RRC signaling indicating the set of parameters for the one or more pilot signals, where the set of parameters indicates a multiplexing associated with the one or more pilot signals. In some examples, the control signaling component 1040 may be configured as or otherwise support a means for transmitting DCI indicating the set of parameters for a selected pilot signal of the one or more pilot signals.

In some examples, the scheduling component 1045 may be configured as or otherwise support a means for scheduling transmission of the wireless channel via the set of resources in accordance with the superimposition of the one or more pilot signals over the wireless channel.

In some examples, the set of parameters includes an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

In some examples, the one or more pilot signals are orthogonal to each other based on one or more orthogonal spreading codes, a FDMing of the one or more pilot signals with the wireless channel, a TDMing of the one or more pilot signals with the wireless channel, a CDMing of the one or more pilot signals with the wireless channel, or any combination thereof, and where the one or more pilot signals are non-orthogonal to the wireless channel.

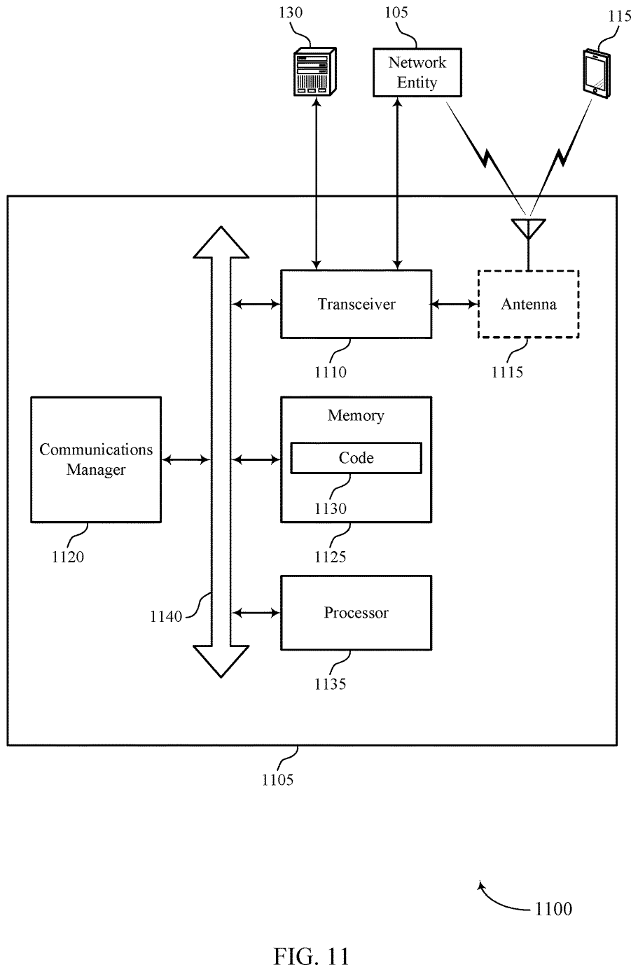

FIG. 11 illustrates a diagram of a system 1100 including a device 1105 that supports a super-lightweight SSB structure using superimposed pilots in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, a memory 1125, code 1130, and a processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or memory components (for example, the processor 1135, or the memory 1125, or both), may be included in a chip or chip assembly that is installed in the device 1105. In some examples, the transceiver may be operable to support communications via one or more communications links (e.g., a communication link 125, a backhaul communication link 120, a midhaul communication link 162, a fronthaul communication link 168).

The memory 1125 may include RAM and ROM. The memory 1125 may store computer-readable, computer-executable code 1130 including instructions that, when executed by the processor 1135, cause the device 1105 to perform various functions described herein. The code 1130 may be stored in a non-transitory computer-readable medium such as system memory or another type of memory. In some cases, the code 1130 may not be directly executable by the processor 1135 but may cause a computer (e.g., when compiled and executed) to perform functions described herein. In some cases, the memory 1125 may contain, among other things, a BIOS which may control basic hardware or software operation such as the interaction with peripheral components or devices.

The processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1135 may be configured to operate a memory array using a memory controller. In some other cases, a memory controller may be integrated into the processor 1135. The processor 1135 may be configured to execute computer-readable instructions stored in a memory (e.g., the memory 1125) to cause the device 1105 to perform various functions (e.g., functions or tasks supporting super-lightweight SSB structure using superimposed pilots). For example, the device 1105 or a component of the device 1105 may include a processor 1135 and memory 1125 coupled with the processor 1135, the processor 1135 and memory 1125 configured to perform various functions described herein. The processor 1135 may be an example of a cloud-computing platform (e.g., one or more physical nodes and supporting software such as operating systems, virtual machines, or container instances) that may host the functions (e.g., by executing code 1130) to perform the functions of the device 1105. The processor 1135 may be any one or more suitable processors capable of executing scripts or instructions of one or more software programs stored in the device 1105 (such as within the memory 1125). In some implementations, the processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the memory 1125, the code 1130, and the processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with other network entities 105, and may include a controller or scheduler for controlling communications with UEs 115 in cooperation with other network entities 105. In some examples, the communications manager 1120 may support an X2 interface within an LTE/LTE-A wireless communications network technology to provide communication between network entities 105.

The communications manager 1120 may support wireless communication at a network entity in accordance with examples as disclosed herein. For example, the communications manager 1120 may be configured as or otherwise support a means for transmitting a first control message indicating a set of parameters for one or more pilot signals to be monitored by a UE. The communications manager 1120 may be configured as or otherwise support a means for transmitting a second control message indicating a set of resources associated with the one or more pilot signals in accordance with a superimposition of the one or more pilot signals over a wireless channel. The communications manager 1120 may be configured as or otherwise support a means for transmitting the one or more pilot signals via the set of resources in accordance with the set of parameters indicated in the first control message and the superimposition of the one or more pilot signals over the wireless channel.

By including or configuring the communications manager 1120 in accordance with examples as described herein, the device 1105 may support techniques for a super-lightweight SSB structure using pilot signals superimposed over data of a wireless channel, which may decrease SSB overhead and decrease latency as the superimposed pilot signals use the same time and frequency resources as the data.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, the processor 1135, the memory 1125, the code 1130, or any combination thereof. For example, the code 1130 may include instructions executable by the processor 1135 to cause the device 1105 to perform various aspects of super-lightweight SSB structure using superimposed pilots as described herein, or the processor 1135 and the memory 1125 may be otherwise configured to perform or support such operations.

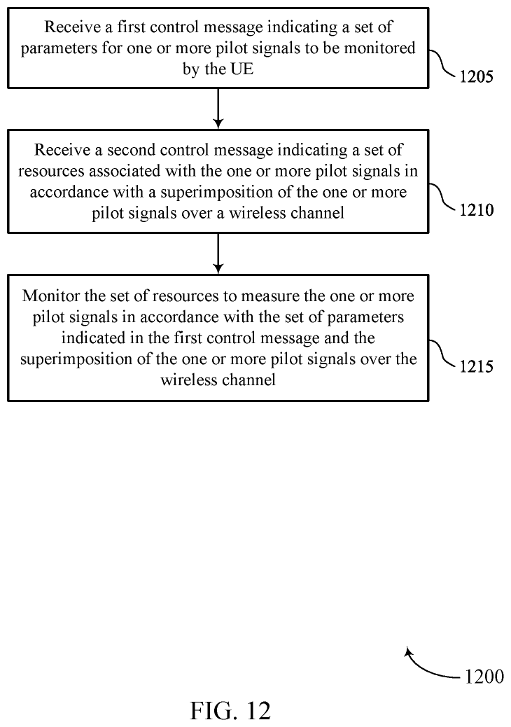

FIG. 12 illustrates a flowchart illustrating a method 1200 that supports a super-lightweight SSB structure using superimposed pilots in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving a first control message indicating a set of parameters for one or more pilot signals to be monitored by the UE. The operations of 1205 may be performed in accordance with examples as disclosed herein. In some examples, aspects of the operations of 1205 may be performed by a parameter component 625 as described with reference to FIG. 6.

At 1210, the method may include receiving a second control message indicating a set of resources associated with the one or more pilot signals in accordance with a superimposition of the one or more pilot signals over a wireless channel. The operations of 1210 may be performed in accordance with examples as disclosed herein. In some examples, aspects of the operations of 1210 may be performed by a resource component 630 as described with reference to FIG. 6.

At 1215, the method may include monitoring the set of resources to measure the one or more pilot signals in accordance with the set of parameters indicated in the first control message and the superimposition of the one or more pilot signals over the wireless channel. The operations of 1215 may be performed in accordance with examples as disclosed herein. In some examples, aspects of the operations of 1215 may be performed by a monitoring component 635 as described with reference to FIG. 6.

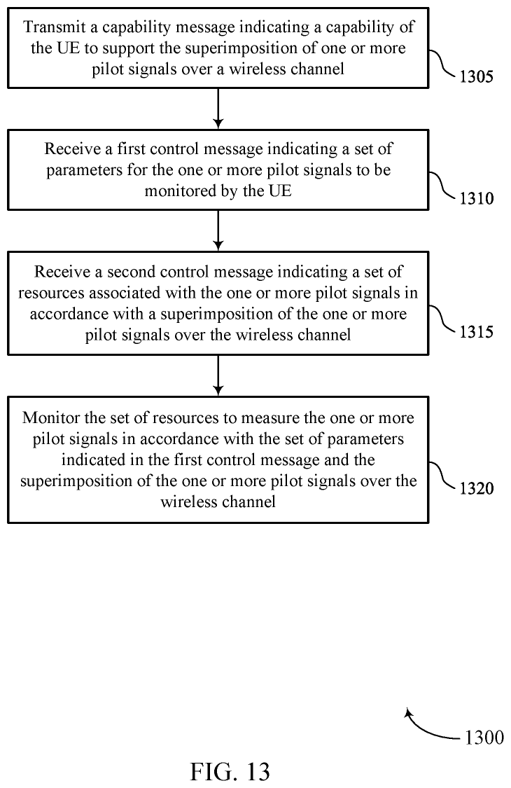

FIG. 13 illustrates a flowchart illustrating a method 1300 that supports a super-lightweight SSB structure using superimposed pilots in accordance with one or more aspects of the present disclosure. The operations of the method 1300 may be implemented by a UE or its components as described herein. For example, the operations of the method 1300 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1305, the method may include transmitting a capability message indicating a capability of the UE to support the superimposition of one or more pilot signals over a wireless channel. The operations of 1305 may be performed in accordance with examples as disclosed herein. In some examples, aspects of the operations of 1305 may be performed by a capability component 640 as described with reference to FIG. 6.

At 1310, the method may include receiving a first control message indicating a set of parameters for the one or more pilot signals to be monitored by the UE. The operations of 1310 may be performed in accordance with examples as disclosed herein. In some examples, aspects of the operations of 1310 may be performed by a parameter component 625 as described with reference to FIG. 6.

At 1315, the method may include receiving a second control message indicating a set of resources associated with the one or more pilot signals in accordance with a superimposition of the one or more pilot signals over the wireless channel. The operations of 1315 may be performed in accordance with examples as disclosed herein. In some examples, aspects of the operations of 1315 may be performed by a resource component 630 as described with reference to FIG. 6.

At 1320, the method may include monitoring the set of resources to measure the one or more pilot signals in accordance with the set of parameters indicated in the first control message and the superimposition of the one or more pilot signals over the wireless channel. The operations of 1320 may be performed in accordance with examples as disclosed herein. In some examples, aspects of the operations of 1320 may be performed by a monitoring component 635 as described with reference to FIG. 6.

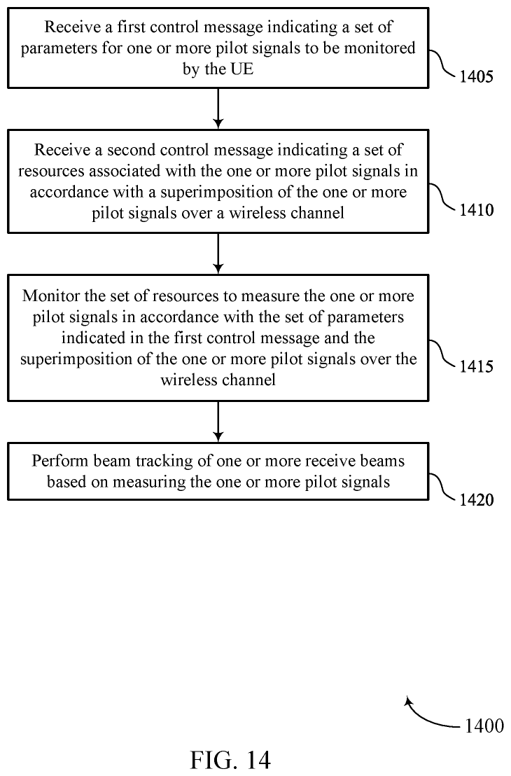

FIG. 14 illustrates a flowchart illustrating a method 1400 that supports a super-lightweight SSB structure using superimposed pilots in accordance with one or more aspects of the present disclosure. The operations of the method 1400 may be implemented by a UE or its components as described herein. For example, the operations of the method 1400 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1405, the method may include receiving a first control message indicating a set of parameters for one or more pilot signals to be monitored by the UE. The operations of 1405 may be performed in accordance with examples as disclosed herein. In some examples, aspects of the operations of 1405 may be performed by a parameter component 625 as described with reference to FIG. 6.

At 1410, the method may include receiving a second control message indicating a set of resources associated with the one or more pilot signals in accordance with a superimposition of the one or more pilot signals over a wireless channel. The operations of 1410 may be performed in accordance with examples as disclosed herein. In some examples, aspects of the operations of 1410 may be performed by a resource component 630 as described with reference to FIG. 6.

At 1415, the method may include monitoring the set of resources to measure the one or more pilot signals in accordance with the set of parameters indicated in the first control message and the superimposition of the one or more pilot signals over the wireless channel. The operations of 1415 may be performed in accordance with examples as disclosed herein. In some examples, aspects of the operations of 1415 may be performed by a monitoring component 635 as described with reference to FIG. 6.

At 1420, the method may include performing beam tracking of one or more receive beams based on measuring the one or more pilot signals. The operations of 1420 may be performed in accordance with examples as disclosed herein. In some examples, aspects of the operations of 1420 may be performed by a beam tracking component 650 as described with reference to FIG. 6.

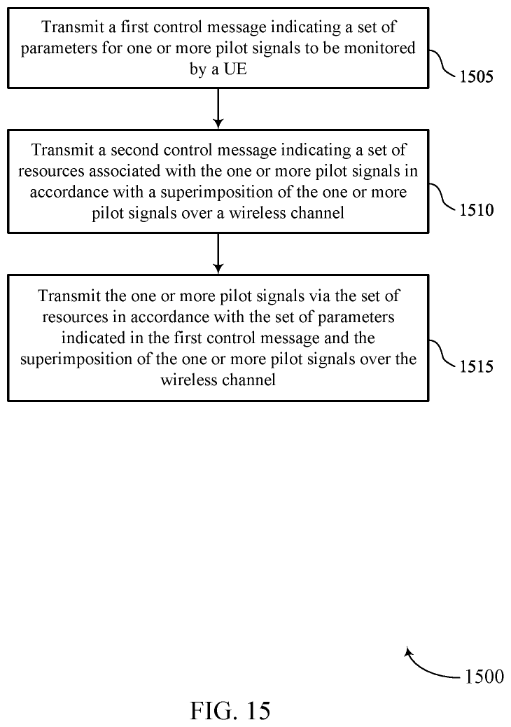

FIG. 15 illustrates a flowchart illustrating a method 1500 that supports a super-lightweight SSB structure using superimposed pilots in accordance with one or more aspects of the present disclosure. The operations of the method 1500 may be implemented by a network entity or its components as described herein. For example, the operations of the method 1500 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1505, the method may include transmitting a first control message indicating a set of parameters for one or more pilot signals to be monitored by a UE. The operations of 1505 may be performed in accordance with examples as disclosed herein. In some examples, aspects of the operations of 1505 may be performed by a pilot signal component 1025 as described with reference to FIG. 10.

At 1510, the method may include transmitting a second control message indicating a set of resources associated with the one or more pilot signals in accordance with a superimposition of the one or more pilot signals over a wireless channel. The operations of 1510 may be performed in accordance with examples as disclosed herein. In some examples, aspects of the operations of 1510 may be performed by a superimposition component 1030 as described with reference to FIG. 10.

At 1515, the method may include transmitting the one or more pilot signals via the set of resources in accordance with the set of parameters indicated in the first control message and the superimposition of the one or more pilot signals over the wireless channel. The operations of 1515 may be performed in accordance with examples as disclosed herein. In some examples, aspects of the operations of 1515 may be performed by a wireless channel component 1035 as described with reference to FIG. 10.

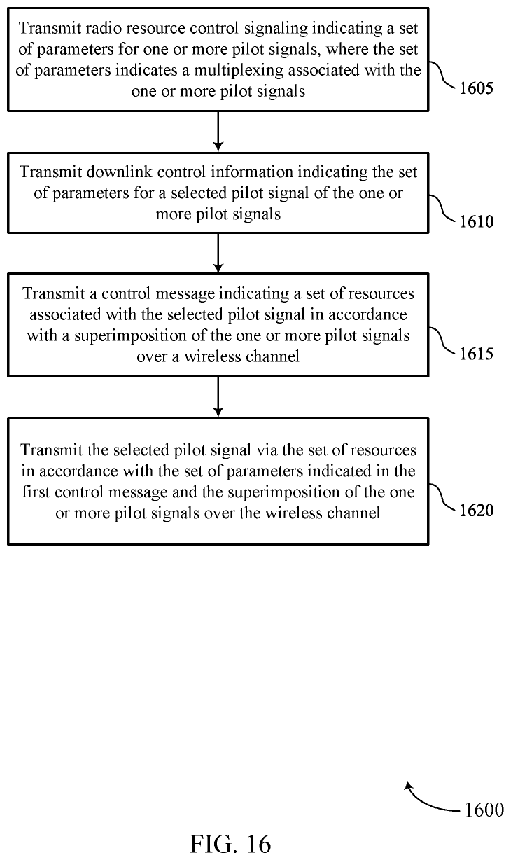

FIG. 16 illustrates a flowchart illustrating a method 1600 that supports a super-lightweight SSB structure using superimposed pilots in accordance with one or more aspects of the present disclosure. The operations of the method 1600 may be implemented by a network entity or its components as described herein. For example, the operations of the method 1600 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1605, the method may include transmitting RRC signaling indicating a set of parameters for one or more pilot signals, where the set of parameters indicates a multiplexing associated with the one or more pilot signals. The operations of 1605 may be performed in accordance with examples as disclosed herein. In some examples, aspects of the operations of 1605 may be performed by an control signaling component 1040 as described with reference to FIG. 10.

At 1610, the method may include transmitting DCI indicating the set of parameters for a selected pilot signal of the one or more pilot signals. The operations of 1610 may be performed in accordance with examples as disclosed herein. In some examples, aspects of the operations of 1610 may be performed by a control signaling component 1040 as described with reference to FIG. 10.

At 1615, the method may include transmitting a control message indicating a set of resources associated with the selected pilot signal in accordance with a superimposition of the one or more pilot signals over a wireless channel. The operations of 1615 may be performed in accordance with examples as disclosed herein. In some examples, aspects of the operations of 1615 may be performed by a superimposition component 1030 as described with reference to FIG. 10.

At 1620, the method may include transmitting the selected pilot signal via the set of resources in accordance with the set of parameters indicated in the first control message and the superimposition of the one or more pilot signals over the wireless channel. The operations of 1620 may be performed in accordance with examples as disclosed herein. In some examples, aspects of the operations of 1620 may be performed by a wireless channel component 1035 as described with reference to FIG. 10.

The following provides an overview of aspects of the present disclosure:

Aspect 1: A method for wireless communication at a UE, comprising: receiving a first control message indicating a set of parameters for one or more pilot signals to be monitored by the UE: receiving a second control message indicating a set of resources associated with the one or more pilot signals in accordance with a superimposition of the one or more pilot signals over a wireless channel; and monitoring the set of resources to measure the one or more pilot signals in accordance with the set of parameters indicated in the first control message and the superimposition of the one or more pilot signals over the wireless channel.

Aspect 2: The method of aspect 1, further comprising: transmitting a capability message indicating a capability of the UE to support the superimposition of the one or more pilot signals over the wireless channel.

Aspect 3: The method of any of aspects 1 through 2, wherein receiving the second control message comprises: receiving DCI indicating the set of resources associated with the one or more pilot signals in accordance with the superimposition of the one or more pilot signals over the wireless channel.

Aspect 4: The method of any of aspects 1 through 3, further comprising: receiving RRC signaling indicating the set of parameters for the one or more pilot signals, wherein the set of parameters indicates a multiplexing associated with the one or more pilot signals; and receiving DCI indicating the set of parameters for a selected pilot signal of the one or more pilot signals.

Aspect 5: The method of any of aspects 1 through 4, further comprising: performing beam tracking of one or more receive beams based at least in part on measuring the one or more pilot signals.

Aspect 6: The method of any of aspects 1 through 5, further comprising: performing an iterative demodulation process on the set of resources associated with the one or more pilot signals, wherein the iterative demodulation process demodulates the wireless channel and the one or more pilot signals separately in accordance with the superimposition of the one or more pilot signals over the wireless channel.

Aspect 7: The method of any of aspects 1 through 6, wherein the set of parameters comprises an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

Aspect 8: The method of any of aspects 1 through 7, wherein the one or more pilot signals are orthogonal to each other based at least in part on one or more orthogonal spreading codes, a FDMing of the one or more pilot signals with the wireless channel, a TDMing of the one or more pilot signals with the wireless channel, a CDMing of the one or more pilot signals with the wireless channel, or any combination thereof, and wherein the one or more pilot signals are non-orthogonal to the wireless channel.

Aspect 9: A method for wireless communication at a network entity, comprising: transmitting a first control message indicating a set of parameters for one or more pilot signals to be monitored by a UE: transmitting a second control message indicating a set of resources associated with the one or more pilot signals in accordance with a superimposition of the one or more pilot signals over a wireless channel; and transmitting the one or more pilot signals via the set of resources in accordance with the set of parameters indicated in the first control message and the superimposition of the one or more pilot signals over the wireless channel.

Aspect 10: The method of aspect 9, further comprising: receiving a capability message indicating a capability of the UE to support the superimposition of the one or more pilot signals over the wireless channel.

Aspect 11: The method of any of aspects 9 through 10, wherein transmitting the second control message comprises: transmitting DCI indicating the set of resources associated with the one or more pilot signals in accordance with the superimposition of the one or more pilot signals over the wireless channel.

Aspect 12: The method of any of aspects 9 through 11, further comprising: transmitting RRC signaling indicating the set of parameters for the one or more pilot signals, wherein the set of parameters indicates a multiplexing associated with the one or more pilot signals; and transmitting DCI indicating the set of parameters for a selected pilot signal of the one or more pilot signals.

Aspect 13: The method of any of aspects 9 through 12, further comprising: scheduling transmission of the wireless channel via the set of resources in accordance with the superimposition of the one or more pilot signals over the wireless channel. Aspect 14: The method of any of aspects 9 through 13, wherein the set of parameters comprises an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

Aspect 15: The method of any of aspects 9 through 14, wherein the one or more pilot signals are orthogonal to each other based at least in part on one or more orthogonal spreading codes, a FDMing of the one or more pilot signals with the wireless channel, a TDMing of the one or more pilot signals with the wireless channel, a CDMing of the one or more pilot signals with the wireless channel, or any combination thereof, and wherein the one or more pilot signals are non-orthogonal to the wireless channel.

Aspect 16: An apparatus for wireless communication at a UE, comprising a processor; memory coupled with the processor; and instructions stored in the memory and executable by the processor to cause the apparatus to perform a method of any of aspects 1 through 8.

Aspect 17: An apparatus for wireless communication at a UE, comprising at least one means for performing a method of any of aspects 1 through 8.

Aspect 18: A non-transitory computer-readable medium storing code for wireless communication at a UE, the code comprising instructions executable by a processor to perform a method of any of aspects 1 through 8.

Aspect 19: An apparatus for wireless communication at a network entity, comprising a processor: memory coupled with the processor; and instructions stored in the memory and executable by the processor to cause the apparatus to perform a method of any of aspects 9 through 15.

Aspect 20: An apparatus for wireless communication at a network entity, comprising at least one means for performing a method of any of aspects 9 through 15.

Aspect 21: A non-transitory computer-readable medium storing code for wireless communication at a network entity, the code comprising instructions executable by a processor to perform a method of any of aspects 9 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive a first control message indicating a set of parameters for one or more pilot signals to be monitored by the UE;
receive a second control message indicating a set of resources associated with the one or more pilot signals in accordance with a superimposition of the one or more pilot signals over a wireless channel; and monitor the set of resources to measure the one or more pilot signals in accordance with the set of parameters indicated in the first control message and the superimposition of the one or more pilot signals over the wireless channel.

2. The apparatus of claim 1, wherein the instructions are further executable by the processor to cause the apparatus to:
transmit a capability message indicating a capability of the UE to support the superimposition of the one or more pilot signals over the wireless channel.

3. The apparatus of claim 1, wherein the instructions to receive the second control message are executable by the processor to cause the apparatus to:
receive downlink control information indicating the set of resources associated with the one or more pilot signals in accordance with the superimposition of the one or more pilot signals over the wireless channel.

4. The apparatus of claim 1, wherein the instructions are further executable by the processor to cause the apparatus to:
receive radio resource control signaling indicating the set of parameters for the one or more pilot signals, wherein the set of parameters indicates a multiplexing associated with the one or more pilot signals; and
receive downlink control information indicating the set of parameters for a selected pilot signal of the one or more pilot signals.

5. The apparatus of claim 1, wherein the instructions are further executable by the processor to cause the apparatus to:
perform beam tracking of one or more receive beams based at least in part on measuring the one or more pilot signals.

6. The apparatus of claim 1, wherein the instructions are further executable by the processor to cause the apparatus to:
perform an iterative demodulation process on the set of resources associated with the one or more pilot signals, wherein the iterative demodulation process demodulates the wireless channel and the one or more pilot signals separately in accordance with the superimposition of the one or more pilot signals over the wireless channel.

7. The apparatus of claim 1, wherein the set of parameters comprises an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

8. The apparatus of claim 1, wherein the one or more pilot signals are orthogonal to each other based at least in part on one or more orthogonal spreading codes, a frequency division multiplexing of the one or more pilot signals with the wireless channel, a time division multiplexing of the one or more pilot signals with the wireless channel, a code division multiplexing of the one or more pilot signals with the wireless channel, or any combination thereof, and wherein the one or more pilot signals are non-orthogonal to the wireless channel.

9. An apparatus for wireless communication at a network entity, comprising:
a processor;
memory coupled with the processor; and
instructions stored in the memory and executable by the processor to cause the apparatus to:
transmit a first control message indicating a set of parameters for one or more pilot signals to be monitored by a user equipment (UE);
transmit a second control message indicating a set of resources associated with the one or more pilot signals in accordance with a superimposition of the one or more pilot signals over a wireless channel; and transmit the one or more pilot signals via the set of resources in accordance with the set of parameters indicated in the first control message and the superimposition of the one or more pilot signals over the wireless channel.

10. The apparatus of claim 9, wherein the instructions are further executable by the processor to cause the apparatus to:
receive a capability message indicating a capability of the UE to support the superimposition of the one or more pilot signals over the wireless channel.

11. The apparatus of claim 9, wherein the instructions to transmit the second control message are executable by the processor to cause the apparatus to:
transmit downlink control information indicating the set of resources associated with the one or more pilot signals in accordance with the superimposition of the one or more pilot signals over the wireless channel.

12. The apparatus of claim 9, wherein the instructions are further executable by the processor to cause the apparatus to:
transmit radio resource control signaling indicating the set of parameters for the one or more pilot signals, wherein the set of parameters indicates a multiplexing associated with the one or more pilot signals; and
transmit downlink control information indicating the set of parameters for a selected pilot signal of the one or more pilot signals.

13. (canceled)

14. The apparatus of claim 9, wherein the set of parameters comprises an indication of one or more ports associated with the one or more pilot signals, a span of symbols associated with the one or more pilot signals within the set of resources associated with the one or more pilot signals, an indication of resource blocks associated with the one or more pilot signals within the set of resources associated with the one or more pilot signals, an indication of multiplexing between a set of ports associated with the one or more pilot signals, a power allocation associated with the one or more pilot signals, a beam identifier associated with the one or more pilot signals, or any combination thereof.

15. The apparatus of claim 9, wherein the one or more pilot signals are orthogonal to each other based at least in part on one or more orthogonal spreading codes, a frequency division multiplexing of the one or more pilot signals with the wireless channel, a time division multiplexing of the one or more pilot signals with the wireless channel, a code division multiplexing of the one or more pilot signals with the wireless channel, or any combination thereof, and wherein the one or more pilot signals are non-orthogonal to the wireless channel.

16. A method for wireless communication at a user equipment (UE), comprising:
receiving a first control message indicating a set of parameters for one or more pilot signals to be monitored by the UE;
receiving a second control message indicating a set of resources associated with the one or more pilot signals in accordance with a superimposition of the one or more pilot signals over a wireless channel; and
monitoring the set of resources to measure the one or more pilot signals in accordance with the set of parameters indicated in the first control message and the superimposition of the one or more pilot signals over the wireless channel.

17. The method of claim 16, further comprising:
transmitting a capability message indicating a capability of the UE to support the superimposition of the one or more pilot signals over the wireless channel.

18. The method of claim 16, wherein receiving the second control message comprises:
receiving downlink control information indicating the set of resources associated with the one or more pilot signals in accordance with the superimposition of the one or more pilot signals over the wireless channel.

19. The method of claim 16, further comprising:
receiving radio resource control signaling indicating the set of parameters for the one or more pilot signals, wherein the set of parameters indicates a multiplexing associated with the one or more pilot signals; and
receiving downlink control information indicating the set of parameters for a selected pilot signal of the one or more pilot signals.

20. The method of claim 16, further comprising:
performing beam tracking of one or more receive beams based at least in part on measuring the one or more pilot signals.

21. The method of claim 16, further comprising:
performing an iterative demodulation process on the set of resources associated with the one or more pilot signals, wherein the iterative demodulation process demodulates the wireless channel and the one or more pilot signals separately in accordance with the superimposition of the one or more pilot signals over the wireless channel.

22-30. (canceled)
